(19) United States
(12) Patent Application Publication
(10) Pub. No.: US 2006/0192848 A1
(43) Pub. Date: Aug. 31, 2006

(54) Video conferencing system

(75) Inventor: Hong Tao Ni, Balwyn (AU)

Correspondence Address: BROWN, RAYSMAN, MILLSTEIN, FELDER & STEINER LLP, 900 THIRD AVENUE, NEW YORK, NY, 10022, US

(73) Assignee: Camelot Technology Associates Ltd.

(21) Appl. No.: 11/346,866

(22) Filed: Feb. 1, 2006

Related U.S. Application Data
(63) Continuation of application No. 10/755,067, filed on Jan. 9, 2004.

(51) Int. Cl. H04N 7/14

(52) U.S. Cl. 348/14.08

(57) ABSTRACT

A video conferencing method utilizes video data from cameras situated at the respective locations of user terminals. The video data from each of the cameras is provided to a user terminals, where it is processed into a compressed video data stream by software installed and executed in the user terminal. The compressed video data streams are provided to a multi-point control unit that switches them into output video data streams without decompressing them. Each user terminal receives, decompresses and displays a selected combination of said decompressed output video data streams according to a selection by the user of the user terminal.

### BACKGROUND OF THE INVENTION

1. Field of the Invention

The present invention relates generally to multimedia communications. More particularly, the present invention relates to multi-user video conferencing systems.

2. Description of the Related Art

Modern video conferencing systems permit multiple users to communicate with each other over a distributed communications network. However, most video conferencing systems utilizing commonly available technology, such as personal computers, inevitably have relatively poor audio and video quality. This is in large part because the standards underlying such video conferencing systems (such as the H.323 codec format) were developed at a time when the widely available communication systems had relatively limited bandwidth and personal computers had modest processing power and ability to process video data in real-time. Although higher quality video conferencing systems have been developed, they require the use of communications networks with a relatively large amount of dedicated bandwidth (such as T-1 lines or ISDN networks) and/or specialized conferencing equipment.

Another aspect making it difficult to provide a widely acceptable video conferencing system of high quality is that delays in the delivery of pieces of the audio or video data result in highly objectionable pauses in the user presentation. Unfortunately, the predominant transport protocol on the Internet, the Transport Control Protocol (TCP), is designed with relatively relaxed timing constraints and latency problems. As a consequence, video conference systems conventionally use the User Datagram Protocol (UDP), or some other protocol such as the Real Time Protocol (RTP) which contains less timing delays. Unfortunately, a severe disadvantage of UDP and other protocols is that they are highly structured and require that many headers and other overhead data be included in the bit stream. This other overhead data imposed by the transport protocol can significantly increase the total amount of data that needs to be communicated, and thus greatly increases the amount of bandwidth that would otherwise be necessary.

Another conventional consideration is that the relative lack of processing power, or at least the poor ability to quickly process video conferencing signals, in personal computers, cause video conferencing systems to utilize a multi-point control unit (MCU) for specialized processing of video signals and other data. The MCU receives the incoming video signal from the camera of each conference participant, processes the received incoming video signals and develops a single composite signal that is distributed to all of the participants. This video signal typically contains the video signals of a combination of the conference participants and the audio signal of one participant. Because processing is centralized at the MCU, a participant has limited capability to alter the signal that it receives so that it, for example, can receive the video signals for a different combination of participants. This reliance on central processing of the incoming video signals also limits the number of conference participants since the MCU has to simultaneously process the incoming video signals for all of the participants.

### BRIEF SUMMARY

It is an object of the following described preferred embodiments of the invention to provide a real-time video conferencing system with improved reliability, confidentiality, connection capacity, and audio/video quality.

Another one of the objects of a preferred embodiment of the invention is the ability to provide video conferencing signals of increased resolution.

A further object of a preferred embodiment of the invention is to provide a high quality video conference system that can be easily implemented over the Internet using the Transport Control Protocol and can be easily installed as a high-end software system at a widely available user terminal, such as a personal computer.

It is an object of the preferred embodiments of the invention to provide a convenient user interface that permits the user to alter the audio/video signal that they receive.

It is a further object of the invention for the user to be able to alter the combination of participants for which they receive audio/video signals and to change the display resolution of received video signals.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

FIG. 1 illustrates an exemplary video conferencing system according to a preferred embodiment of the invention.

FIG. 2 illustrates the video media stream structure in the preferred embodiment.

FIG. 3 shows the processing of the macroblock of a video frame in a preferred embodiment.

FIG. 4 is a block diagram showing the processing of coding interframes in a preferred embodiment of the invention.

FIG. 5 shows the improved motion estimation used in a preferred embodiment of the invention.

FIG. 6 illustrated an example of image rotation addressed in the improved motion estimation of the preferred embodiment of the invention.

FIG. 7 illustrates 16 different patterns used to describe the movement of an object in a preferred embodiment of the invention.

FIG. 8 is an example of the bit stream structure of the outgoing video stream from a client terminal in a preferred embodiment of the invention.

FIG. 9 is an illustration of the multi-queue and multi-channel architecture utilized in the network connection in a preferred embodiment of the invention.

FIG. 10 is a display screen of a client terminal while in main screen only mode according to a preferred embodiment of the invention.

FIG. 11 is a display screen of a client terminal while in main screen plus 4 sub-screen mode according to a preferred embodiment of the invention.

FIG. 12 is a display screen of a client terminal while in main screen plus 8 sub-screen mode according to a preferred embodiment of the invention.

FIG. 13 is a display screen of a client terminal while in full screen having 1 main screen plus 10 sub-screens according to a preferred embodiment of the invention.

FIG. 14 is a display screen for a client terminal to connect to a video conference according to a preferred embodiment of the invention.

FIG. 15 is a video setting display window in a preferred embodiment of the invention.

FIG. 16 is an audio setting display window in a preferred embodiment of the invention.

### DETAILED DESCRIPTION OF THE PREFERRED EMBODIMENTS

Before beginning a detailed description of the preferred embodiments of the invention, the following statements are in order. The preferred embodiments of the invention are described with reference to an exemplary video conferencing system. However, the invention is not limited to the preferred embodiments in its implementation. The invention, or any aspect of the invention, may be practiced in any suitable video system, including a videophone system, video server, video player, or video source and broadcast center. Portions of the preferred embodiments are shown in block diagram form and described in this application without excessive detail in order to avoid obscuring the invention, and also in view of the fact that specifics with respect to implementation of such a system are known to those of ordinary skill in the art and may be dependent upon the circumstances. In other words, such specifics are variable but should be well within the purview of one skilled in the art. Conversely, where specific details are set forth in order to describe example embodiments of the invention, it should be apparent to one skilled in the art that the invention can be practiced without, or with variation of, these specific details. In particular, where particular display screens are shown, these display screens are mere examples and may be modified or replaced with different displays without departing from the invention.

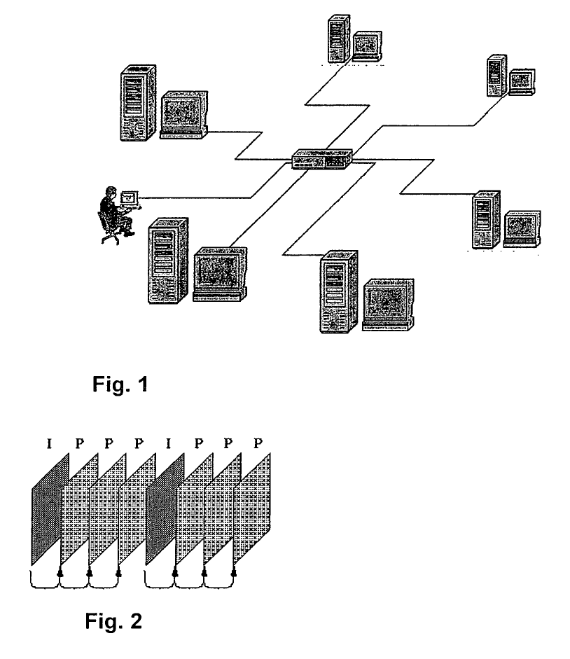

FIG. 1 is a diagram of the architecture and environment of an exemplary real-time video conferencing system according to a preferred embodiment of the invention. The system includes what is referred to as a multi-point control unit (MCU), but as described hereafter this MCU is significantly different in its functionality than the MCU of conventional video conferencing systems. The conference system has a plurality of user client terminals. Although an administrator's terminal and a certain number of user client terminals are shown as being connected to the MCU in FIG. 1, this is for illustration purposes only. There may be any number of connected administrator and user's client terminals. Indeed, as described hereafter, the number of connected user client terminals may vary during a video conference, as the users have the ability to join and drop from a video conference at their own control.

Furthermore, the connections between the terminals shown in FIG. 1 are not fixed connections. They are switched network connections over open communication networks. Preferably, the network connections are broadband connections through an Internet Service Provider (ISP) of the client's choice using the Transport control Protocol and Internet Protocol (TCP/IP) at the network layer of the ISO network model. As known in the art, various access networks, firewalls and routers can be set up in a variety of different network configurations, including, for example, Ethernet local area networks. In certain circumstances, such as a local area network, one of a certain number of ports, such as ports above 2000, should be opened/forwarded. The video conference system is designed and optimized to work with broadband connections (i.e., connections providing upload/download speeds of at least 128 kbps) at the user client terminals. However, it does not require a fixed bandwidth, and may suitably operate at upload/download speeds of 256 kbps, 512 kbps or more at the user client terminals.

Each client terminal is preferably a personal computer (PC) with a SVGA display monitor capable with a display resolution of 800×600 or better, a set of attached speakers or headphones, microphone and full duplex sound card. As described further below, the display monitor may need to display a video signal in a large main screen at a normal resolution mode of 320×240@25 fps or a high resolution mode of 640×480@25 fps. It must also be able to simultaneously display a plurality of small sub-screens, each having a display resolution of 160×120@25 fps. Each PC has a camera associated therewith to provide a video signal at the location of the client terminal (typically a video signal of the user at the location). The camera may be a USB 1.0 or 2.0 compatible camera providing a video signal directly to the client terminal or a professional CCD camera combined with a dedicated video capture card to generate a video signal that can be received by the client terminal.

The video conferencing system preferably utilizes client terminals having the processing capabilities of a high-speed Intel Pentium 4 microprocessor with 256 MB of system memory, or better. In addition, the client terminals must have Microsoft Windows or other operating system software that permits it to receive and store a computer program in such a manner that allows it to utilize a low level language associated with the microprocessor and/or other hardware elements and having an extended instruction set appropriate to the processing of video. While computationally powerful and able to process video conferencing data in real-time, such personal computers are now commonly available.

Each one of the client terminals performs processing of its outgoing video signals and incoming video signals and other processing related to operation of the video conferencing system. In comparison with conventional video conferencing systems, the MCU of the preferred embodiments thus needs to perform relatively little video processing since the video processing is carried out in the client terminals. The MCU captures audio/video data streams from all clients terminals in real-time and then redistributes the streams back to any client terminal upon request. Thus, the MCU closely approximates the functionality of a video switch unit—needing only a satisfactory network connection sufficient to support the total bandwidth of all connected user terminals. This makes it relatively easy to install and support video conferences managed by the MCU at locations that do not have a great deal of network infrastructure.

FIG. 2 illustrates the video media stream structure utilized in the preferred embodiments. There are two different types of frames. Intraframes (I-frames) are utilized as key frames. The I-frames may be compressed according to the JPEG (Joint Picture Electronics Group) standard with additional dynamic macro block vector memory analysis technology. The Interframes (P-frames) are coded based on the difference between it and the predicted I-frame. The video frames may be of various formats, types and resolution: 8n*4×8n*3=n*(32*24) which covers CCIR 601 QCIF (160*120), CIF (352*288) and 4CIF (768*576), e.g. 32*24, 64*4, 96*72, 1 60*120, 320*240, 512*384, 640*480, 768*576, 1600*1200, etc.

Each frame is divided into a plurality of macroblocks, each macroblock preferably consisting of a block of 16×16 pixels. Preferably, the system does not use the conventional 4:2:0 format in which the color information in the frame is downsampled by determining the average of the respective color values in each 2×2 subblock of four pixels. Instead, the color components in the I-frames, or the color components in both of the I-frames and the P-frames, are preferably downsampled to a ratio for Y-Cr-Cb of 4:2:2. With a 4:2:2 format, a macroblock is divided into four 8*8 Y-blocks (luminance), two 8*8 Cr-blocks (chrominance-red) and two 8*8 Cb-blocks (chrominance-blue). These are sampled in the stream sequence of Y-Cr-Y-Cb-Y-Cr-Y-Cb. With this method, the color loss introduced through compression is reduced to a minimal level, which in comparison to the conventional 4:2:0 format, yields superior video quality. Although such additional color detail is conventionally avoided, when used in conjunction with the other features of the video conference system described in this application which improve the transport of the data through a TCP/IP network, the result is a high quality video.

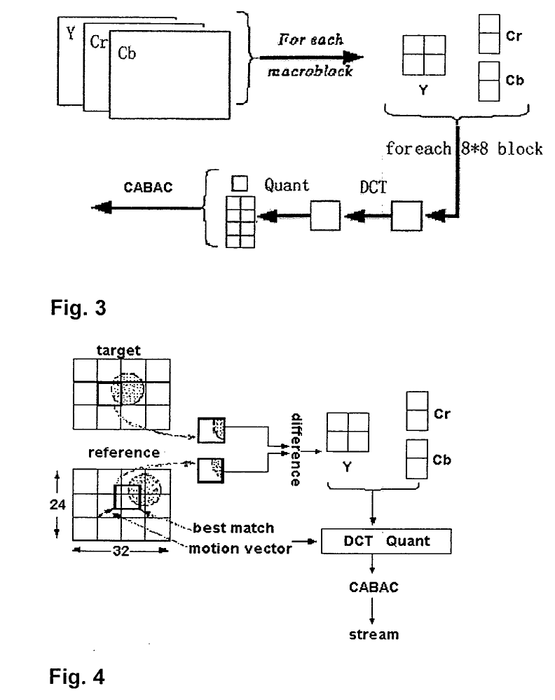

As shown in FIG. 3, the data from the frame is then processed, in groups of 2×2 luminance blocks with two 2×1 chrominance blocks, before being passed to the unique context-based adaptive arithmetic coder (CABAC) of the preferred embodiments. A discrete cosine transformation (DCT) is performed and then quantization coefficients are determined as known to one of ordinary skill in the art. Typically, Huffman coding is used at this point. However, the unique context-based adaptive arithmetic coder (CABAC) is used instead in the preferred embodiments to obtain a higher video compression ratio.

The preferred method of coding the P-frames is shown in FIG. 4. The I-frame which serves as the reference image is compressed, coded and stored in memory. For each macroblock in the P-frame containing the target image to be coded with respect to the reference image, a motion estimation process is performed that searches for the macroblock in the reference image that provides the best match. Depending upon the amount of motion that has occurred, the macroblock in the reference image that provides the best match may not be at the same location within the frame as the macroblock being coded in the target image of the P-frame. FIG. 4 shows an example where this is the case.

If the search finds a suitable match for the macroblock, then only a relative movement vector will be coded. If system CPU computation loading approaches full, a coding method similar to intraframe coding will be used. If no suitable match is found, then a comparison with the background image in the P-frame is performed to determine if a new object is identified. In such a case, the macroblock will be coded and stored in memory and will be sent through the decoder for the next object search. This coding process has the advantages that there is a smaller final data matrix and a minimal number of bits is needed for coding.

Many conventional video compression algorithms don't perform vector analysis on video images. They do not record the same or similar objects in the sequential image frames and the key frames. The object image is transmitted in conventional motion estimation techniques regardless of whether the object is undergoing translation or rotation.

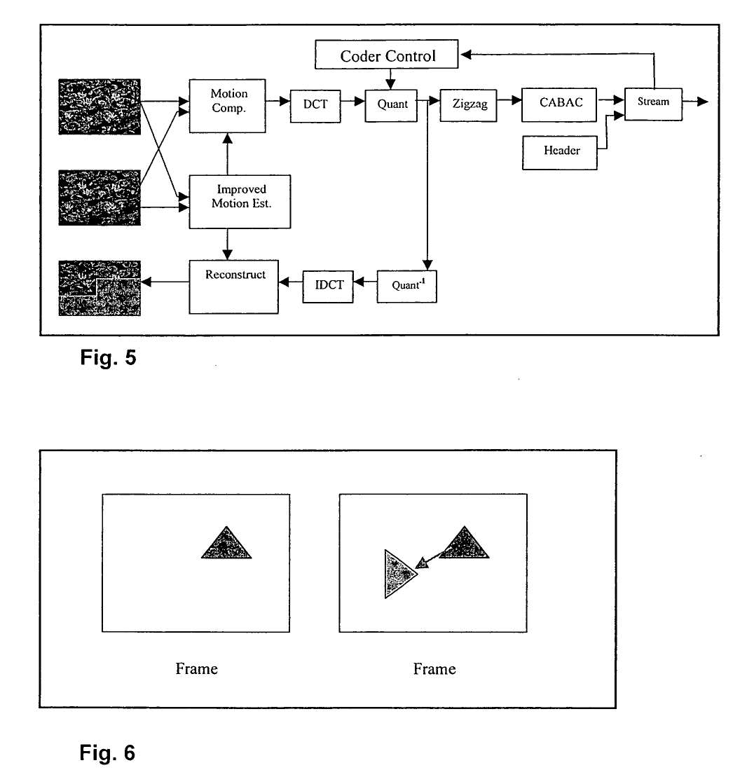

The improved motion estimation of the Context-Based Adaptive Arithmetic Coder (CABAC) used for video compression in the preferred embodiments is shown in FIGS. 5-7. In the improved motion estimation scheme shown in FIGS. 5-7, rotation, mirror and other matching methods are added to improve the precision of motion estimation. To compensate for the extra computation that must be performed in the user terminal, the software utilizes and leverages the low level language advantageously made available for use with modern central processing units, such as the Intel Pentium 4, supporting, for example, MMX, SSE, EES2 and similar extended instruction sets to meet demands such as those for general video image processing. Due to the introduction of the improved motion vector estimation, the amount of motion estimation that can be performed in real-time with a software implemented motion estimation process can be doubled, on average, thus greatly increasing the video compression ratio.

For example, ITU H.263 estimation does not give a motion vector analysis solution on an object going though rotation such as shown in FIG. 6. But the improved motion estimation method of the preferred embodiment gives a very simple solution.

The ITU H.263 standard uses the following formula to compute motion estimation, where F₀ and F₁ represent the current frame and the reference frame; k, I are coordinates of the current frame; x, y are coordinates of the reference frame; and N is the size of the macroblocks.

$$SAD ( x , y , k , l ) = {\sum }_{i , j = 0}^{N - 1} \vert {F}_{- 1} ( i + x , j + y ) - {F}_{0} ( i + k , j + l ) \vert$$

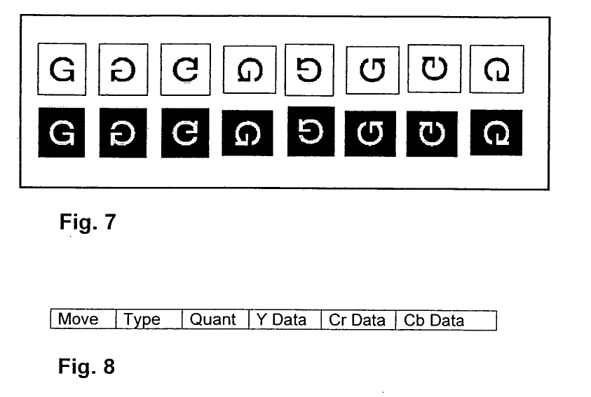

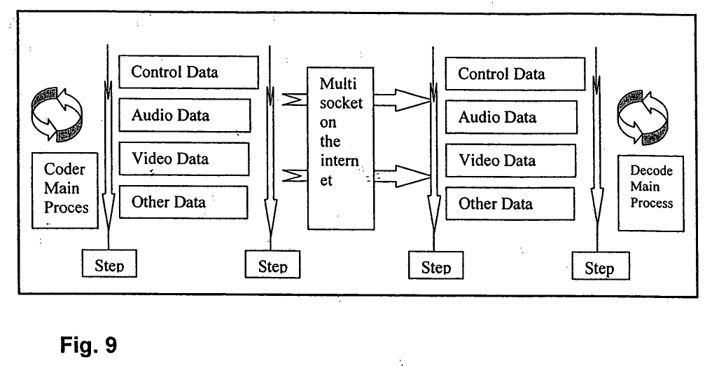

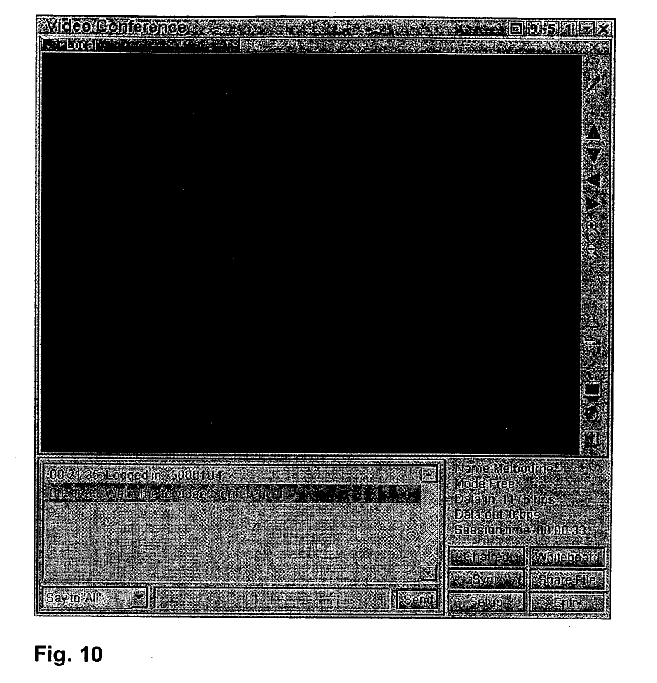

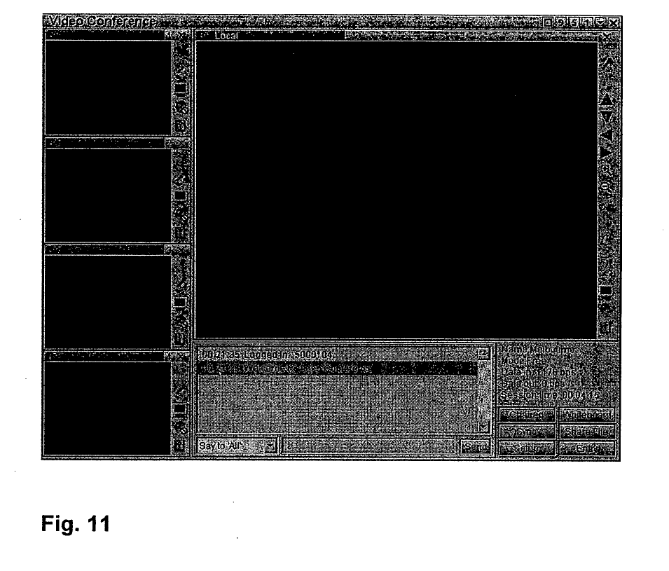

In contrast, the improved motion estimation formula of the preferred embodiments can be expressed by the following equation, where T represents the transformation of one of the 16 different patterns shown in FIG. 7:

$$SAD ( x , y , k , l ) = {\sum }_{i , j = 0}^{N - 1} \vert {F}_{- 1} ( i + x , j + y ) - T [ {F}_{0} ( i + k , j + l ) ] \vert$$

The resulting data for a macroblock is preferably arranged into a bit stream having the structure illustrated in FIG. 8. In this structure, the Move header contains the motion data for the macroblock (sequence number, coordinates, angle). The Type header indicates the motion type, preferably by reference to one of the sixteen types illustrated in FIG. 7. The Quant header contains the Macroblock sequential number.

There are several advantages to this bit stream structure. It minimizes the data block. It is easy to transmit over a data communications network. The size of the mosaic can be minimized if any block is missing. There may be any number of reasons why a block is missing, e.q. insufficient cpu processing power, transmission failure, etc. A particularly important advantage is that the number and size of headers for the data block are minimized. For example, typical video conferencing protocols, such as UDP, need specified protocol descriptors that may substantially increase the volume of data to be transmitted and the bandwidth that is necessary.

In general, the data volume generated by the video decoder of the preferred embodiments is only about 50% of the data that would be necessary if the video was decoded according to the ITU H.263 standard. Furthermore, this reduction is data is obtained while have more flexibility over the frame sizes, and still delivering better video quality in terms of possible mosaic, color accuracy, image loss.

The bit stream structure of the preferred embodiments is optimized for transmission utilizing the TCP/IP protocol, which is one of the most common protocols for many data networks, including the Internet. As mentioned previously, video conferencing systems typically avoid transmission over TCP/IP networks even though it utilizes less overhead in terms of data block headers, etc., because the transmission of packets often incur delay and the resulting latency is unacceptable in a video conferencing system. However, the preferred embodiments utilize a unique technique for holding the data stream in a buffer and transmitting it over a TCP/IP network that it results in a video conferencing system free from undesireable latency effects.

According to this technique, after a point-to-point connection is established between the two devices, multiple sockets are opened (called A, B, C, and D herein for simplicity), which correspond to an equal number of channels. As known, these channels are logical channels rather than predefined paths through the network and may experience different routing through routers and other network devices as they traverse the TCP/IP network. Due to the intermittent nature of TCP/IP channels and data flow or router throttle management on carrier/lSP end, any one of the channels may be jammed or blocked at any time.

The data buffer is configured to store a number of data blocks equal to the number of channels, and these buffered data blocks are then duplicated as necessary to produce multiple copies of each of the data blocks. The data blocks are then ordered into different internal sequences according to the number of channels. In the example of there being four channels, four data blocks (d1, d2, d3, and d4) can be preferably ordered as follows:
d4, d3, d2, d1=======→channel A
d3, d2, d1, d4=======→channel B
d2, d1, d4, d3=======→channel C
d1, d4, d3, d2=======→channel D
   and then transferred over the TCP/IP network. (Of course, a different number of channels can be used.) If all of the channels are open, then the 4 data blocks are sent, and received, concurrently. If one, two or three, channels are blocked, then the four components sent to the remaining open channels will preclude any resultant prejudice to the video conferencing system by the blocked channel(s). Prejudice is avoided not only because of the redundancy in using multiple channels to send the same data blocks, but also because the data blocks are ordered into different sequences.

FIG. 8 illustrates a transmission architecture utilized in the preferred embodiment to deliver higher realized bandwidth and connection reliability over TCP/IP networks through the combination of concurrent multi-queue and multi-channel transmission architecture. As known to those of ordinary skill in the art, multiple queues are used to control the transmission of data over TCP/IP networks. Suppose there are “N” queues and that “M” logical channels, and that each queue of data blocks is duplicated and sequentially numbered and feed to all channels as described above, the total queues will then be:

Queueᵢⱼ

i=1, 2 . . . N
j=1, 2 . . . M

Once a queue is transmitted, all other duplicated queues are deleted and a new queue is duplicated and numbered. The data blocks are preferably prioritized based on their importance to providing real-time video communications. From top to bottom of prioritization, there are four preferred levels:

1^{st}—Control data (Ring, camera control . . . )

2nd—Audio data

3rd—Video data

4th—other data (file transfer . . . )

This concurrent multi-queue and multi-channel transmission architecture delivers a much more reliable connection and smoother data flow over TCP/IP channels than was previously known. On average, the realized bandwidth is increased by 50%, which results in significant improvement in the quality of the video conferencing system.

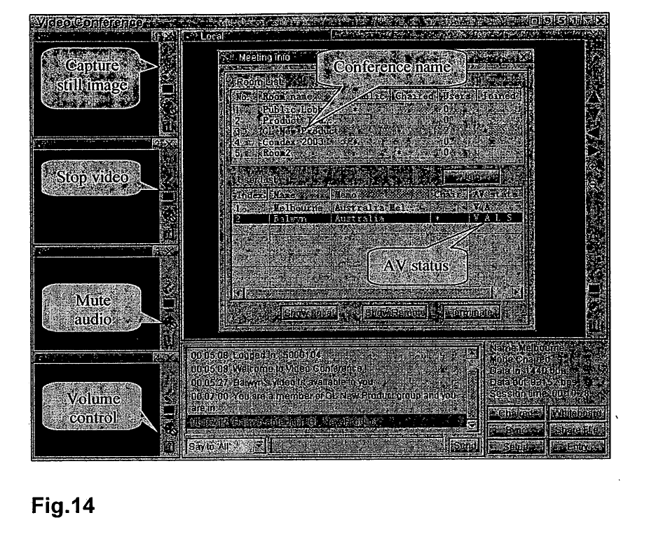

Not only do the aforementioned features of the preferred embodiments result in significant improvements in the quality and flexibility of the video conferencing data, those improvements in turn enable significant advances in providing a user friendly interface. FIG. 14 illustrates a display window from which a user may select the remote client conferencing site with which they wish to connect and view from a listing of conferences. The window may be provided automatically upon launching a software application or, e.g., when the user right clicks on a display screen they are viewing. The user left clicks on the conference site on the screen they want to switch to and checks for proper video and audio operation. The user clicks on the “X” button at the top right on the screen to exit and close the conference system.

An alternative log-on screen may also be provided in which a registered user enters information identifying a conference center by number and/or name, along with their username and password, and then click on a button to connect to the conference. The screen may have save password and auto logon features utilized in the logon screen, in the same manner that is known for other types of applications.

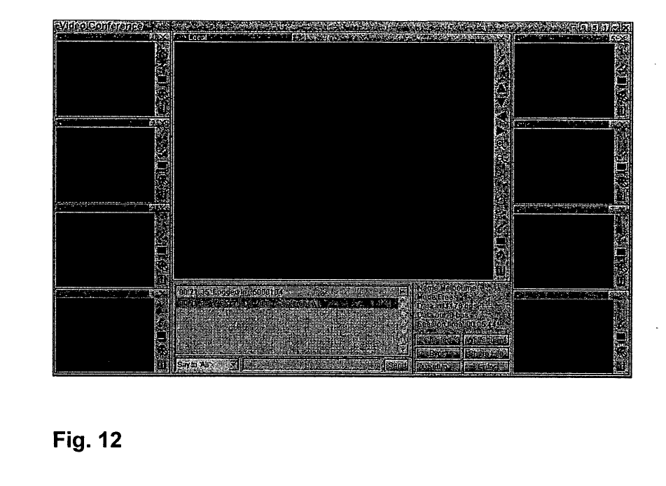

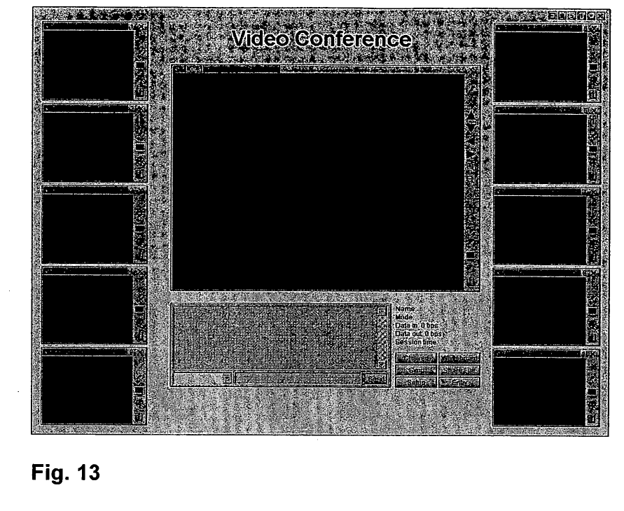

Once connected to a video conference, the user may select from among many screens, including the examples shown in FIGS. 10-13. FIG. 10 shows the display in a main screen only mode. FIG. 11 shows the display in a main screen+4 sub-screens mode. FIG. 12 shows the display in a main screen+8 sub-screens mode. FIG. 13 shows the display in a full screen mode with one main screen and 10 sub screens. Preferably, the user is not limited to these examples, but may view any number of screens simultaneously, up to the maximum number of users. Also, the video on the main screen can be switched back and forth with any sub-screen by a simple left click on any live sub-screen to switch it with the main screen. However, there may also be a sync button. Once the chairperson clicks the sync button, all sites will have the same screen view as the chairperson's, except the local screen. There may also be a whiteboard that all users can use for presentations. The high efficiency transport picture smoothing algorithm described above greatly improves the system resources utilization to make this possible.

These screens also provide various icons or buttons to enable user selection of various functions. The user may click on the record icon to start capture of the conference video. The user may select a site from the site list in the message selection to start private message chat. All messages are invisible to other users. A public message may be sent by selecting say to “All” to send messages to all sites (users, clients) in the conference. The user may click on the mute icon to activate a mute function muting the sound coming through the conference site. The screen may also indicate the current status of listed online meeting groups and users. As shown in FIG. 14, a (V A S L) system may be used where the letters mean the following:

V The site is sending video

A The site is sending audio

S The other site is receiving the user3 s audio

L The other site is receiving the user's video

The screens also preferably display the connection status. This includes the site name (client, user), the mode (chaired or free mode), data in speed (inbound data in kbps), data out speed (outbound data in kbps) and session time (in format hh:mm:ss). In the free mode, every client user works the same as a non-chaired conference. In chaired mode, each client user should ring the bell icon to get permission to speak and none of the users can switch screens or use a whiteboard. To give a permission, the chairperson will open the site, then click on the sync button to broadcast the site to all client users. To draw attention from all users, the chairperson should “Show Remote”, then click on “sync” button to let all client users view and listen to the chair (although the chairperson's local screen can't be synchronized). When a pan-tilt-zoom camera is installed at a user site, both the local user and the chairperson con control the camera. The chairperson has priority over the camera control.

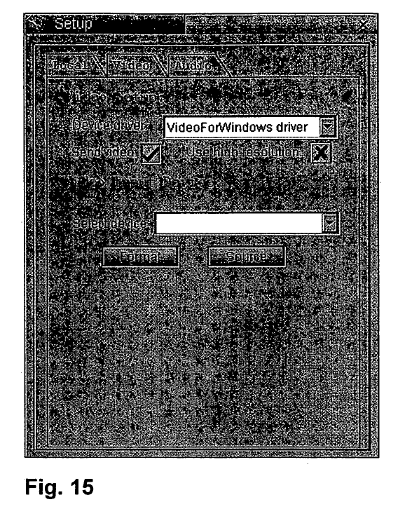

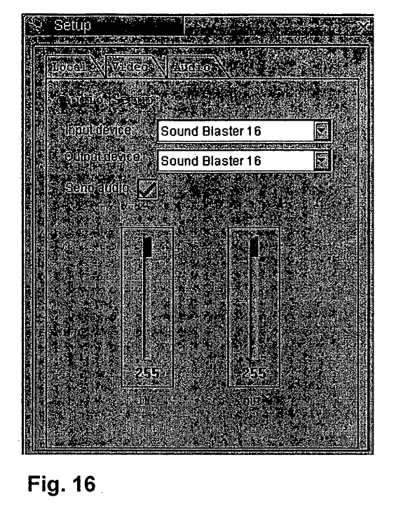

FIGS. 15 and 16 show the video and audio settings available at the user terminal. FIG. 15 shows the video setting. There is a video device driver drop down menu which can be highlighted to select the appropriate video driver. There is a resolution section or check box which enables the user to set the resolution at wither 640×480 or 320×240. There is a check box to tick to send video streams through. The video input device hardware equipment may be selected through a drop down menu or other interactive feature. A video format feature, such as the button shown in FIG. 15, allows the appropriate video format (PAL or NTSC) to be selected. A video source feature, such as the button shown in FIG. 15, allows the appropriate video source to be selected.

FIG. 16 shows the user audio setting. There is an audio input device driver drop down menu which can be highlighted to select the appropriate audio input device. There is an audio output device driver drop down menu which can be highlighted to select the appropriate audio output device. There is a check box to tick to send audio streams through. There is an audio input volume feature to adjust the volume of the microphone and an audio output volume feature to adjust the volume of the speakers/headphone.

As stated above, this patent application describes several preferred embodiments of the invention. However, the several features and aspects of the invention described herein may be applied in any suitable video system. Furthermore, the invention may be applied to any variety of different applications. These applications include, but are not limited to, video phones, video surveillance, distance education, medical services, traffic control, and security and crowd control.

What is claimed is:

1. A video conferencing method, comprising:
obtaining video data from a plurality of cameras situated at the respective locations of at least two different user terminals;
providing the video data from said plurality of cameras to said respective user terminals;
processing the video data in the respective user terminals to obtain compressed video data streams, said processing being executed by software installed and executed in the user terminal;
providing the compressed video data streams to a multi-point control unit, said multi-point control unit switching said compressed video data streams into a plurality of output video data streams, without decompressing said compressed video data streams; and
at each one of said user terminals, decompressing said output video data streams and displaying a selected combination of said decompressed output video data streams according to a selection by the user of the user terminal.

2. A method in accordance with claim 1, wherein the compressed video data streams are provided over a TCP/IP network.

3. A method in accordance with claim 2, wherein each one of said compressed video data streams is provided over a plurality of different channels in said TCP/IP network.

4. A method in accordance with claim 2, wherein the data in said compressed video data streams is organized into a plurality of different ordered sequences, each one of said plurality of different ordered sequences being provided through a respective one of said plurality of different channels.

5. A method in accordance with claim 1, in which the video data is compressed by estimating the motion between frames in the video, the estimated motion including the amount of rotation of an object in the frames.

6. A method in accordance with claim 5, in which the amount of rotation is categorized as corresponding to one of a plurality of predetermined types of rotation.

7. A method in accordance with claim 1, in which the compressed video data streams contain macroblocks of image data, in which the ratio of luminance to chrominance components is 4:2:2.

8. A method in accordance with claim 7, in which the compressed video data streams are organized into blocks of data, the blocks of data including a move header, a type header and a Quant header.

9. A method in accordance with claim 1, wherein the user selection controls the resolution of the displayed video data.

10. A method in accordance with claim 1, wherein the user selection controls the combination of decompressed video output data streams.

11. A method in accordance with claim 1, wherein one of the decompressed video output data streams is displayed as a main screen and other video output data streams are displayed as sub-screens.

12. A method in accordance with claim 11, wherein the user selection controls which one of the decompressed video output data streams is displayed as a main screen.

13. A method in accordance with claim 10, wherein users can join or leave a video conference by interacting with a user interface displayed on the user terminal.

14. A user terminal, said user terminal comprising:
a camera providing a video signal;
a display;
a central processing unit; and
a software program installed in said user terminal, said software program utilizing a low level language supported by the central processing unit and an extended instruction set to cause said central processing unit to: 1) compress said video signal provided by said camera and provide said compressed video signal to a multi-point control unit via a TCP/IP network; and 2) receive compressed video signals from said multi-point control unit and decompress said compressed video signals for display on said display.

15. A user terminal as recited in claim 14, wherein said compression comprises improved motion estimation categorizing rotation occurring in said video signal as one of a predetermined number of different rotation types, said compressed video signals provided to said multi-point control unit having a data block containing a header indicating said rotation type for the data in said data block.

16. A software program stored in a tangible medium, said software program utilizing a low level language supported by the central processing unit of a computer and an extended instruction set to cause said central processing unit to: 1) compress a video signal provided to said computer from a camera and provide said compressed video signal to a multi-point control unit via a TCP/IP network; and 2) receive compressed video signals from said multi-point control unit and decompress said compressed video signals for display on said computer.

17. A software program in accordance with claim 16, wherein said compression comprises improved motion estimation categorizing rotation occurring in said video signal as one of a predetermined number of different rotation types, said compressed video signals provided to said multi-point control unit having a data block containing a header indicating said rotation type for the data in said data block.
